(19) United States
(12) Patent Application Publication
(10) Pub. No.: US 2007/0097099 A1
(43) Pub. Date: May 3, 2007

(54) Information management unit and method for controlling data flow from electronic pens

(75) Inventors: Johan Gustavsson, Huddinge (SE); Per Hoglin, Tullinge (SE)

Correspondence Address: BIRCH STEWART KOLASCH & BIRCH, PO BOX 747, FALLS CHURCH, VA, 22040-0747, US

(73) Assignee: ANOTO IP LIC HB, Lund (SE)

(21) Appl. No.: 10/577,485

(22) PCT Filed: Oct. 15, 2004
(86) PCT No.: PCT/SE04/01487

§ 371 Date: Apr. 27, 2006

Related U.S. Application Data
(60) Provisional application No. 60/515,704, filed on Oct. 31, 2003.

(30) Foreign Application Priority Data
Oct. 31, 2003 (SE) 0302884-2

(51) Int. Cl. G09G 5/00

(52) U.S. Cl. 345/179

(57) ABSTRACT

An information management unit is arranged in an electronic network as a flow path controller for electronic data between electronic pens and destination units, the electronic data comprising handwriting data recorded by the electronic pens and one or more pen-resident parameters. The information management unit receives at least part of the electronic data from an electronic pen; maps the thus-received electronic data against one or more flow control objects to identify a relevant processing instruction, wherein the flow control object corresponds to a value of one of the pen-resident parameters; and directs the electronic data flow to a destination unit based on the thus-identified processing instruction.

### CROSS-REFERENCE TO RELATED APPLICATIONS

The present application claims the benefit of Swedish patent application No. 0302884-2, filed on Oct. 31, 2003, and U.S. provisional patent application No. 60/515,704, filed on, Oct. 31, 2003, which both are hereby incorporated by reference.

### FIELD OF THE INVENTION

The present invention relates to information management systems, and in particular to the distribution of electronic data from electronic pens to destination units in such systems.

### BACKGROUND ART

Electronic pens can be used for generation of electronic information that reflects handwritten entries on a base. Such electronic information may be generated by the electronic pen itself, the base or an external supervision device sensing the motion pattern of the pen on the base.

It would be desirable to incorporate such electronic pens in an information management system such that the electronic information could be efficiently conveyed to different destination units for further processing.

In US 2003/0061188, US 2003/0046256 and US 2002/0091711, which are herewith incorporated by reference, the present Applicant has suggested such information management systems in which a position code is applied to each base to code a plurality of absolute positions thereon. By reading the position code, the electronic pens are capable of electronically recording a sequence of positions that reflect their own motion on the base.

The position code on each base is a subset of a much larger abstract position-coding pattern. Examples of such abstract patterns are described in U.S. Pat. No. 6,663,008, U.S. Pat. No. 6,570,104 and WO 99/50787. The abstract pattern may be dynamically or statically divided into subsets of given size, each such subset being associated in the system with a unique identifier. If each subset is intended for a respective physical page, it is denoted a logic page and is represented by a unique page address. In such a case, each absolute position may be represented by a page address and a local position within the associated logic page.

By dedicating different parts of the abstract pattern to different destination units, the electronic information can be automatically directed from the pen to the correct destination unit for processing. For example, the system may include an intermediary server which, upon receipt of one or more positions from a pen, identifies an associated network address of the correct actor and directs the flow of data to this address.

For example, an actor may provide a position-coded product which is dedicated to one or more general services, such as taking notes, sending electronic mails, sending faxes, etc. Other actors may provide a position-coded product which is dedicated to highly specialized services, such as ordering certain goods, filing time reports, filing inventory lists, etc. All such actors must develop and produce products with a unique position code, by associating parts of the position code with specific processing instructions, suitably supported by corresponding graphics on the product. The actors must also develop a service, i.e. software that communicates with the pens and selectively executes the specific processing instructions on the received data.

A development tool for producing such position-coded products and corresponding service software is disclosed in US 2002/0040816, which is herewith incorporated by reference. Further, a protocol for use in the data exchange with such electronic pens is disclosed in US 2003/0055865, which is herewith incorporated by reference and in which the pens are able to communicate both position data and one or more pen-resident parameters that identify characteristics of the pen or the pen user/owner in the system.

The complexities of developing a product, and supplying the same in sufficient quantities and with adequate circulation on the market, and also of developing a service may serve as a barrier to the introduction and adoption of the electronic pen technology.

### SUMMARY OF THE INVENTION

It is an object of the present invention to provide a solution to, or at least mitigate, the above-mentioned problem.

This and other objects, which will be evident from the following description, are achieved wholly or partly by an information management unit according to claim 1, and a method according to claim 23. Preferred embodiments are defined by the dependent claims.

By including one or more pen-resident parameters in the flow control between the electronic pens and the destination units, it is possible to break up the strict one-to-one relationship between product and service. Generally speaking, electronic data from any one product can be conveyed to any one service. For one, a position-coded product can be used by several actors, i.e. position data which is recorded from one and the same product can be conveyed to different destination units depending on the actual properties of the pen that recorded the position data. This potentially reduces the need for actors to develop and distribute products that are customized to the offered services, since pre-existing products may be utilized.

Additionally, the efforts put into the development of a service can be reduced, or even eliminated, by centralized preprocessing of the electronic data from the pens in conjunction with the flow control. To this end, the inventive flow control can be installed in an existing service to define one or more sub-services that capitalize on the offerings of the existing service. For example, an actor providing communications services, such as electronic mail, via position-coded products may offer other actors to use one or more existing communications services for any other data collection service, provided that the data collection service is intended for use by a confined group of electronic pens. By means of the inventive flow control, the communications service will be able to separate out the electronic data from the confined group of pens, and send this data, possibly after some preprocessing, via the communications service to the destination unit of the relevant actor.

The inventive flow control may be incorporated in an intermediary server, which may have an administrative interface allowing at least the operator of the intermediary server to modify or update the flow control. For example, a new flow control object may be created at will and associated with an arbitrary processing instruction. The flow control object may be created by logically combining selected values of selected control parameters, which are derivable from the electronic data transmitted by the pens. The processing instruction may define a network address of the destination unit, and optionally, a communications channel to the destination unit and/or a format of the electronic data to be conveyed to the destination unit and/or a background image to be included in the data flow to the destination unit.

### BRIEF DESCRIPTION OF THE DRAWINGS

Preferred embodiments of the invention will be described in more detail below with reference to the accompanying drawings.

FIG. 1 shows an information management unit according to one embodiment of the present invention.

FIG. 2 illustrates steps of performing flow control according to an embodiment of the invention.

FIG. 3 illustrates steps of adding a flow control object in the information management unit of FIG. 1.

FIGS. 4a-4c show the information management unit of FIG. 1 as incorporated in three different prior-art information management systems.

### DESCRIPTION OF PREFERRED EMBODIMENTS

The following description is based on the use of the above-identified abstract position-coding pattern, which is subdivided into page units. The page units can be part of superordinate subsets of the pattern. For example, the pattern may contain “segments” which in turn may be divided into a number of “shelves”, each containing a number of “books” which may be divided into a number of aforesaid page units, also called “logic pages”. The position of a certain logic page in the abstract pattern can thus be noted as a page address of the form: section.segment.shelf.book.page, for instance 1.231.841.334.226, more or less like an IP address.

The following description is also based on each product containing position code that corresponds to one or more logic pages. It is to be noted, however, that the position code on a product need not conform with a logic page. Thus, one or more subsets from one or more logic pages may be arbitrarily arranged on the product. The product may also contain functional areas that each is associated with a particular function to operate on any pen strokes therein. Thus, positions coded by the position code within each such functional area are associated with the particular function. Coded positions that fall outside any such functional areas may be associated with a default function, for example that any such positions should be represented as pen strokes, i.e. result in a pure digitalization of the pen movement. Each product is represented by a definition file (PAD file) which identifies the page address(es) of the relevant logic page(s), and defines the mapping of the logic page(s) on the product, such as the placement and size of each functional area on the logic page(s), as well as the associated function. Each product is also represented by a graphics file which defines the human-readable information on the product, i.e. the layout or supporting graphics, which aims at instructing, controlling and/or informing a user.

A pen may record its motion on a position-coded product as a page address and a sequence of local positions on the corresponding logic page. Thus, a physical pen stroke is recorded as an electronic pen stroke in the form of a sequence of positions. The pen may then transmit the recorded position data in the form of one or more page addresses and local positions.

As also identified by way of introduction, the electronic pens store one or more parameters, which may be transmitted in association with the position data. These pen-resident parameters either identify a characteristic of the pen itself or of the owner/user of the pen. The pen-resident parameters include: PEN_ID (a unique identifier of the pen), OPERATOR_ID (a unique identifier of the operator providing network access to the pen), PEN_OWNER_LANGUAGE, PEN_OWNER_NAME, PEN_OWNER_ADDRESS, PEN_OWNER_EMAIL, PEN_OWNER_HOME_PHONE, PEN_OWNER_CELL_PHONE, PEN_OWNER_BUSINESS_PHONE, PEN_OWNER_PAGER, PEN_OWNER_HOME_FAX, and PEN_OWNER_BUSINESS_FAX.

The electronic pens and the position-coded products are suitably combined with infrastructure components in a network-based information management system, to allow for transparent distribution of the recorded position data to adequate destination units.

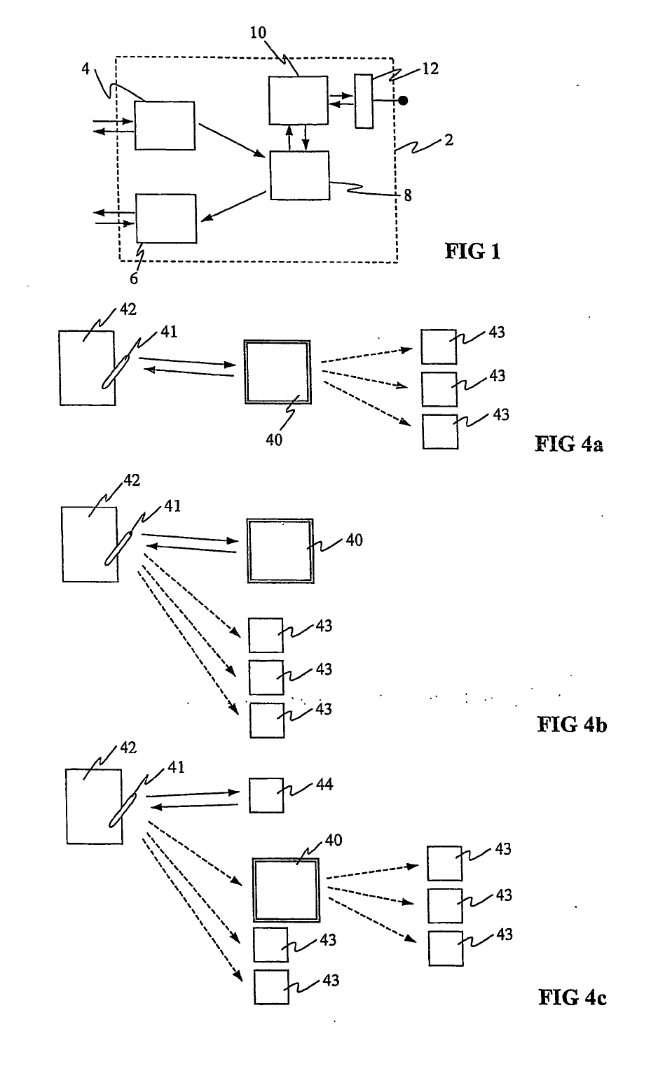

One such infrastructure component is an intermediary server or flow controller 2, as shown in FIG. 1, which controls the flow of data from the pens to the destination units.

The flow controller 2 includes an input interface 4 for communication with the electronic pens, either directly or indirectly, and an output interface 6 for communication with the destination units, either directly or indirectly.

The flow controller 2 also has a processing unit 8 for controlling the flow of data from the pens to the destination units, via the input and output interfaces 4, 6, and a storage 10 which permanently stores rule objects and associated processing instructions. An administrative interface 12 is connected to the storage 10 to provide access to the rule objects and processing instructions, for example allowing an authorized operator to add/delete/edit the rule objects and/or processing instructions.

The flow controller 2 may be implemented as a network server, e.g. a web server, with communication interface hardware, controlling software, a processor (e.g. CPU, DSP, FPGA, ASIC, etc), and storage memory (e.g. RAM, ROM, PROM, EPROM, hard disk, etc).

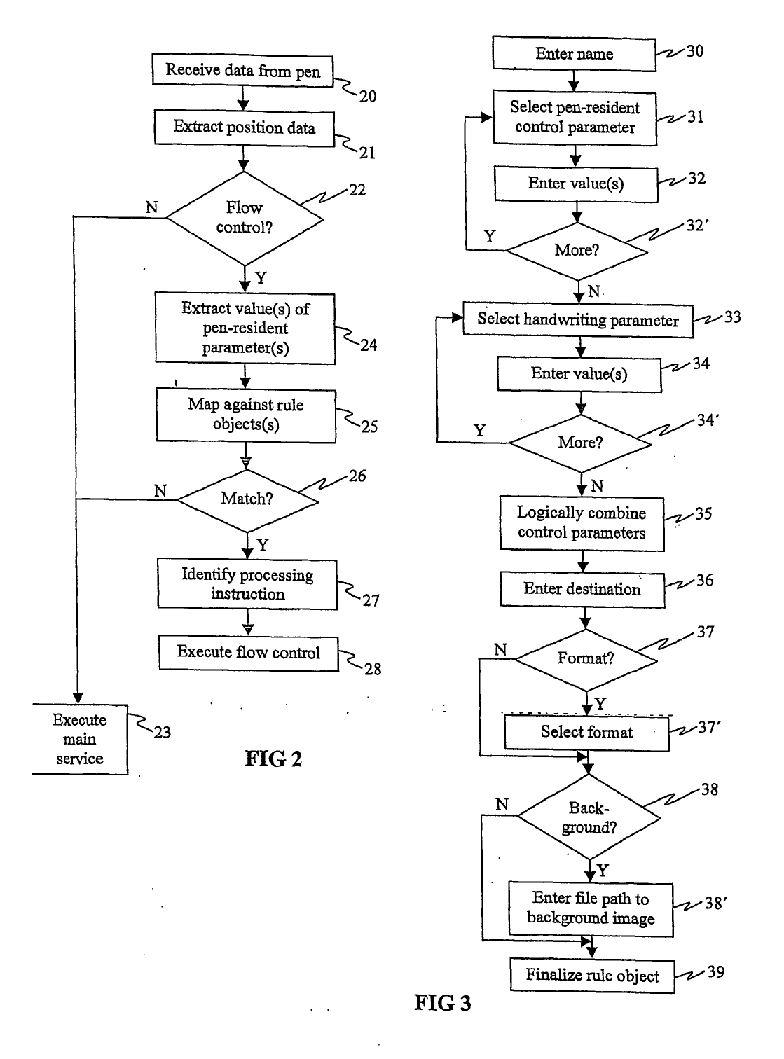

The operation of the flow controller will now be exemplified with reference to FIG. 2. In this example, the flow controller is configured to effect, in addition to flow control, one or more default services.

The processing unit 8 (FIG. 1) receives data from an electronic pen via the input interface (step 20), and extracts one or more position parameters, e.g. the page address (step 21). The value of each such position parameter is matched against the rule objects to identify if flow control is to be effected (step 22). If not, the default service is accessed in conventional manner (step 23). If a match is found, the processing unit extracts values of existing pen-resident parameters in the received data (step 24). These values, optionally together with the position parameter value(s), are then mapped against the rule objects in the storage (step 25). If no match is found, the default service may be executed (step 23). If a match is found, the associated processing instruction is identified (step 27), whereupon flow control is executed based thereon (step 28).

It should be noted that the above steps may be modified. For example, the values of all control parameters (i.e. position and pen-resident parameters) may be extracted in one single step. Additionally, the processing unit may, via the input interface, request transmission of further parameters from the pen. Further, step 22 may be omitted.

The flow controller may also preprocess the data received from the pens. This preprocessing may be at least partly identified by the processing instructions in the storage.

In one embodiment, the flow controller is caused to render an image of the pen strokes as defined by the received data, and to transmit this stroke image to the destination unit, suitably together with a background image that represents the supporting graphics on the product on which the pen strokes were drawn by the pen. To this end, the flow controller identifies and accesses the relevant PAD file and graphics file, either based on the position data or as given by the processing instruction in the storage. The processing instruction may also identify the format in which the stroke image is to be transmitted. Such formats include markup language (e.g. html, xml), raster graphics (e.g. bmp, tiff, gif, png, jpeg) and vector graphics (e.g. svg).

The above embodiment with recreation of the pen strokes has the advantage that a new product may be created based on an existing product, by simply changing the supporting graphics of the existing product. By making the graphics file that represents the supporting graphics accessible to the flow controller, an image of all pen strokes recorded from such a new product can be conveyed to the correct destination unit together with a background image that represents the supporting graphics of the new product. The PAD file may also be made accessible to the flow controller, at least if the new product incorporates changes in the mapping of the logic page to the physical product.

The above concept of forming and conveying a stroke image may also be implemented in flow controllers that effect conventional flow control, i.e. solely based on position data (e.g. page address). The concept gives the general advantage of reducing or eliminating the need for a service provider to develop software implementing the service in the destination unit. Instead, the destination unit may include conventional character interpretation software (OCR/ICR) that receives and extracts relevant data from the stroke image, optionally after merging thereof with an associated background image.

In another embodiment, the flow controller is caused to extract data, by assigning the pen strokes to the functional areas defined in the PAD file and processing the pen strokes based on the respective functions associated with the functional areas, and then transmit such extracted data to the destination unit.

In all embodiments, the flow controller may also be caused to transmit the values of some or all of the extracted flow control parameters to the destination unit.

In these and other embodiments, the flow controller may also identify a communications channel to be used for the data transfer to the destination unit, e.g. electronic mail, fax, SMS, MMS. The communications channel may be given by the processing instruction of the relevant rule object, or by a pen stroke being attributable to a dedicated area (selection box) on the product.

The rule object may include one or more statements that are searched sequentially. Basically, such a statement relates a control parameter to a given value. The control parameter can be any position-related or pen-resident parameter that can be output by the pen and identified by the processing unit of the flow controller. Several statements may be combined by the use of explicit or implicit logic operators (e.g. AND, OR, NAND, NOR, ANDNOT). The values may be given with arbitrary resolution, by the use of wildcards, truncations, ranges etc. Any one of the values may be a NULL value, i.e. the absence of a valid value of a control parameter.

When all such statements of a rule object are found to be true, the associated processing instruction is executed.

Below follows an example in which an implicit logic AND operator is used. The exemplifying rule object is valid for position data from a certain page address, and only for data received from pens that store pen identifiers within a specified range and pen owner electronic mail address within a specific Internet domain. The associated processing instruction defines a destination, a format and a background image.

rule.name=demo1

rule.page=1.231.243.333

rule.penid=AAA-BDC-*

rule.email=*@anoto.com

result.destination=demo@anoto.com

result.format=5

result.background=anotodemo.png

The use of the administrative interface 12 (FIG. 1) will now be further exemplified with reference to FIG. 3, for the case of adding a new rule object and a processing instruction to the storage. The administrative interface is designed to handle low-level accesses to the storage 10 (FIG. 1) of the flow controller. A computer is suitably connected to the interface and provided with a software module that provides access to the interface via a graphical user interface (GUI).

In the example of FIG. 3, the operator is first prompted to enter a name of the rule object to be created (step 30). Then, the software module presents the operator with a list of available pen-resident control parameters (step 31). For each selected control parameter, the operator is prompted to enter a corresponding control value according to a given format (steps 32-32′). Subsequently, the software module presents the operator with a list of available position-related control parameters (step 33). Again, the operator is prompted to enter, for each selected control parameter, a corresponding control value according to a given format (steps 34-34′). The operator is then presented with the option of selecting logic operators to combine the selected control parameters (step 35). By default, the control parameters are combined by logic AND operators. The result parameters are then set by the operator being prompted to enter a destination in the form of network address, e.g. a URL (Uniform Resource Locator), an IP address, an electronic mail address, a fax number, etc (step 36). If necessary, the operator is also prompted to select a communications channel. Further, the operator may also be instructed to identify the location of the PAD file for the product/logic page. The operator may also be given the option to select from a list a format of the resulting data to be conveyed to the destination unit (steps 37-37′), as well as an option to identify the location of a background image (steps 38-38′), whereupon the rule object is finalized and stored in the storage (step 39).

Again, it should be noted that the above is only an example. In another example, the software module may allow the operator to manually type in the above control statements and processing instructions.

FIGS. 4a-4c further illustrate the utility of the flow controller (denoted by reference numeral 40) in information management systems which are based on electronic pens 41 that read off position data from coded products 42 and which convey electronic data from the pens to appropriate destination units 43.

In FIG. 4a, the flow controller 40 is arranged as a central processing unit. Thus, the flow controller 40 receives data from the pens 41 via its input interface 4 (FIG. 1), and conveys the received electronic data, possibly after some preprocessing, via its output interface 6 (FIG. 1) to one of several destination units 43. The flow controller may communicate with the pens in a synchronous two-way protocol, as indicated by the unbroken arrows in FIG. 4a. Alternatively, the flow controller 40 may derive the data from the pens asynchronously, for example by pulling the data as a file object from the pen or by the data being pushed as a file object from the pen to the flow controller.

In FIG. 4b, the flow controller 40 is arranged as a router in the information management system. In this embodiment, the input and output interfaces of the flow controller may be embodied as a single I/O interface. The flow controller 40 receives data from the pens 41, and returns at least the address of the adequate destination unit to the pens. For example, the router may execute a default service of directing the pens 41 to the appropriate destination unit 43 based on one or more position parameters (e.g. page address), as is known from the prior art, with the inventive flow control providing an option to break up the one-to-one relationship between product 41 and destination unit 43 in the system.

The flow control of FIG. 4b can be based on a small subset of the total data flow from the pens 41 to the destination units 43. The flow controller 40 only needs to receive the values of the relevant control parameters. In the case of preprocessing, however, the flow controller may receive at larger set, or all, of the electronic data recorded by the pens.

In FIG. 4c, the flow controller 40 is arranged as a subordinate, yet central, processing unit in the information management system. A router 44 may direct the pens 41 to the flow controller 40, e.g. based on position parameters in the recorded position data. The flow controller 40 communicates with the pens 41 via its input interface, and conveys the received electronic data, possibly after some preprocessing, via its output interface to one of several downstream destination units 43. The flow controller 40 may execute any default general or customized service, as is known form the prior art, with the inventive flow control providing an option to break up the one-to-one relationship between product 41 and destination unit 43 in the system. As mentioned above, the inventive flow control may also include preprocessing that capitalizes on any of the default service(s).

There are many variations that may be made consistent with the present invention. The foregoing description is presented for purposes of illustration and description. It is not exhaustive and does not limit the invention to the precise form disclosed. Modifications and variations are possible in light of the above teachings or may be acquired from practicing the invention.

For example, the invention is applicable in any type of electronic network, be that public or private networks, computer or telecommunication networks, local area or wide area networks, or any combination thereof.

1. An information management unit, which is arranged in an electronic network as a flow path controller for electronic data between electronic pens and destination units, the electronic data comprising handwriting data recorded by the electronic pens and one or more pen-resident parameters, said information management unit comprising:
means for receiving at least part of the electronic data from an electronic pen;
means for storing at least one flow control object and an associated processing instruction, wherein said at least one flow control object corresponds to a value of at least one of the pen-resident parameters;
means for mapping the thus-received electronic data against said at least one flow control object to identify a relevant processing instruction; and
means for directing the electronic data flow to a destination unit based on the thus-identified processing instruction.

2. The information management unit of claim 1, further comprising an administration interface which is connected to said means for storing and allows for entry of said at least one flow control object and the associated processing instruction.

3. The information management unit of claim 2, wherein the administration interface provides for election of at least one control parameter from a set of available pen-resident parameters, for setting a value of each elected control parameter, and for generating the flow control object based thereon.

4. The information management unit of claim 3, wherein the administration interface provides for election of at least two control parameters from a set of available pen-resident parameters and available parameters of the handwriting data, whereupon the values of the thus-elected control parameters are logically combined to form the flow control object.

5. The information management unit of claim 1, wherein said at least one flow control object comprises a set of logically combined values of control parameters present in the electronic data.

6. The information management unit of claim 1, wherein the associated processing instruction defines an address of one of the destination units.

7. The information management unit of claim 6, wherein the means for directing returns the address to the electronic pen.

8. The information management unit of claim 6, wherein the means for directing forwards the received electronic data to the address.

9. The information management unit of claim 6 or 8, wherein the associated processing instruction also identifies an electronic communications service for transporting the received electronic data to the address.

10. The information management unit of claim 1, wherein the associated processing instruction identifies a format of the electronic data flow to the destination unit.

11. The information management unit of claim 10, wherein the format is based on a markup language, vector graphics, or raster graphics.

12. The information management unit of claim 1, wherein the associated processing instruction also identifies an image to be included in the electronic data flow to the destination unit.

13. The information management unit of claim 12, wherein the image is identified as being a background image to the handwriting data.

14. The information management unit of claim 1, which is arranged to recreate the handwriting data based on the electronic data, and to forward the thus-recreated handwriting data to the destination unit.

15. The information management unit of claim 1, wherein said flow control object also corresponds to a value of at least one parameter of the handwriting data recorded by the electronic pen.

16. The information management unit of claim 15, wherein said at least one parameter of the handwriting data comprises a command, or an identifier related to the substrate on which the handwriting data was recorded by the electronic pen.

17. The information management unit of claim 16, wherein the identifier is at least part of an absolute position which is decoded by the electronic pen from a position code on the base during the recording of the handwriting data.

18. The information management unit of claim 1, wherein each of the pen-resident parameters identifies a characteristic of the electronic pen in the electronic network or a characteristic of the user of the electronic pen.

19. The information management unit of claim 1, wherein the pen-resident parameters comprise at least one of an identifier of the electronic pen, an identifier of an operator of the electronic network, an identifier of a geographic location, an electronic mail address, a telephone number, a fax number, and an identifier of a language.

20. The information management unit of claim 1, wherein said value is defined as a range of values.

21. An information management system, comprising a plurality of electronic pens and the information management unit of claim 1.

22. An information management system, comprising a plurality of bases that each has a position code that codes at least one absolute position, a plurality of electronic pens which record their movement on any one of said bases as handwriting data by converting the position code to said at least one absolute position, and the information management unit of claim 17.

23. A method of controlling a flow of electronic data between electronic pens and destination units in an electronic network, the electronic data comprising handwriting data recorded by the electronic pens and one or more pen-resident parameters, said method comprising:
receiving at least part of the electronic data from an electronic pen;
mapping the thus-received electronic data against at least one flow control object to identify a relevant processing instruction, wherein said at least one flow control object corresponds to a value of one of the pen-resident parameters; and
directing the electronic data flow to a destination unit based on the thus-identified processing instruction.

24. The method of claim 23, further comprising providing an administration interface which allows for entry of said at least one flow control object and the associated processing instruction.

25. The method of claim 24, further comprising operating the administration interface to elect at least one control parameter from a set of available pen-resident parameters, enter a value of each elected control parameter, and generate the flow control object based thereon.

26. The method of claim 25, wherein the administration interface provides for election of at least two control parameters, whereupon the values of the thus-elected control parameters are logically combined to form the flow control object.

27. The method of claim 23, wherein said at least one flow control object comprises a set of logically combined control parameter values.
